(19) United States
(12) Patent Application Publication
(10) Pub. No.: US 2007/0071455 A1
(43) Pub. Date: Mar. 29, 2007

(54) Automatic gain control

(76) Inventors: Near Margalit, Westlake Village, CA (US); Zvi Regev, Chatsworth, CA (US)

Correspondence Address: BERGMAN & SONG, LLP, P.O. BOX 400198, CAMBRIDGE, MA, 02140, US

(21) Appl. No.: 11/492,313

(22) Filed: Jul. 25, 2006

Related U.S. Application Data
(60) Provisional application No. 60/701,864, filed on Jul. 25, 2005.

(51) Int. Cl. H04B 10/06

(52) U.S. Cl. 398/202

(57) ABSTRACT

A method and apparatus is presented for providing improved responsiveness of a receiver device. One embodiment includes a receiver device including an avalanche photodiode (APD), a transimpedance amplifier (TIA), and an automatic gain control (AGC) device configured to adjust the reverse bias voltage applied to the APD according to an approximate DC average of the incoming optical signal. A switch in the AGC device may be used to increase or decrease the time constant of an RC combination determining the DC averaging time period, thereby tailoring the response of the AGC device to characteristics of the incoming data pattern. The resulting receiver exhibits improved responsiveness and sensitivity by adapting to varying data patterns including those with data bursts interspersed with gaps.

### CROSS REFERENCE TO RELATED APPLICATION

This application claims the benefit under 35 U.S.C. § 119(e) of U.S. Provisional Application No. 60/701,864, entitled “INSTANTANEOUS AUTOMATIC GAIN CONTROL FOR AVALANCHE PHOTODIODES WITH SWITCHABLE TIME CONSTANT,” filed Jul. 25, 2005, the contents of which are hereby incorporated by reference in their entirety.

### FIELD OF THE INVENTION

The present invention relates to data communication systems and methods and, more particularly, to intermittent data communication systems and methods.

### BACKGROUND OF THE INVENTION

Data communication systems and methods are used in the transmission of information for an increasing variety of purposes, including the control of equipment. As such, improving the performance of data communication systems has become an important focus of attention. For example, optical communication systems are continually undergoing improvement in many areas related to transmission performance such as capacity, bandwidth, and instantaneous data transmission rate.

Certain communication networks require that signals be transmitted continuously, in order to ensure that clock and data recovery devices (e.g., including phase locked loop (PLL) devices) at the receiver are always synchronized and locked to receive the transmitted data. In such networks, if no payload data is awaiting transmission, a special “idle” signal is transmitted. The idle signal maintains the clock and data recovery devices in a synchronized and locked state.

Other data communication systems and methods involve the use of signals that include “burst mode” data. In burst mode data communication, one or more data packets are transmitted substantially continuously over a signal channel during a data transmission time interval. During another quiescent time interval, the signal channel is substantially free of signals. Accordingly, in some data transmission schemes a plurality of quiescent time intervals are disposed chronologically between a corresponding plurality of data transmission time intervals. The combination of the data transmission time intervals and the quiescent time intervals is known as a “datastream.” The quiescent time intervals are referred to as “gaps” in the datastream.

Burst mode data transmission is employed in various applications including automatic control applications. For example, burst mode data transmission is included in various “fly-by-wire” vehicle control systems for vehicles such as wheeled vehicles and aircraft.

An exemplary fly-by-wire control system is used to actuate the aerodynamic control surfaces of an airplane. In such a system, a transducer in an airplane cockpit detects a motion of, for example, a steering yoke. The transducer produces a control signal such as an optical control signal. The signal is conveyed to an actuator over a communication medium. In the case of an optical control signal, a communication medium such as an optical fiber is used to couple the control signal from the transducer to the actuator. The control signal is received at the actuator and the actuator responsively applies a force through a mechanical linkage to an aerodynamic surface of the airplane. For example, the actuator causes a force that pivots an elevator surface in the tail of the airplane.

In some control systems, including some fly-by-wire systems, local servo devices maintain a substantially constant orientation of the control surface until a change is ordered by an action of the transducer. In such a system, active control signals are transmitted between the transducer and the actuator primarily when a change in control surface position is required. The result is a control signal that includes intervals of active data transmission and quiescent intervals. As noted above, such data transmission is referred to as burst mode data transmission.

Burst mode data transmission is also employed in other communication systems, such as computer network and telephony systems. In such systems, it is advantageous to maintain a quiescent communication channel when no payload data is available for transmission. For example, in an optical communication network, a light source, such as a laser, may be used for signaling between two devices. When no data is available for transmission, it may be preferable to extinguish the light source. By turning off the light source during quiescent periods, an operational lifetime of the light source may be extended, power may be conserved, and a risk of personal-injury to, for example, maintenance personnel, may be reduced.

FIG. 1. shows a time domain graph of an exemplary burst mode digital data signal 100. The digital data signal 100 includes bursts 102, 104 of one or more packets of data separated by gaps 101, 103, 105 during which no data is transmitted. In some systems where data is not transmitted continuously, clock and data recovery devices are required to re-synchronize and re-lock for each individual burst or packet of data. To enable such re-synchronization and re-locking, a “preamble” is attached to each burst or packet. The preamble follows a pattern predefined by a communication protocol. An exemplary protocol preamble includes a succession of alternating high and low values (i.e., “1” and “0”) prepended to the data as illustrated in FIG. 2.

FIG. 2 shows a time domain graph of an exemplary datastream 200. The datastream 200 includes a data burst 202 between gaps 201, 203 of the datastream. The burst 202 includes a data portion 208 and a preamble 207 prepended to the data portion 208. The preamble 207 includes a succession of alternating high and low values that continues for a preamble time interval. The preamble time interval is specified to be long enough to permit the clock and data recovery devices to recognize the beginning of a burst and/or, for example, re-synchronize and re-lock the PLLs.

In addition to relocking and resynchronization, burst mode data transmission poses challenges to maintaining signal gain control. In data communications generally, variations in the strength of a received signal can inhibit effective data communication. A receiver must be sensitive enough to detect received signals of comparatively low amplitude. When high amplitude signals are received, however, such a sensitive receiver can become saturated so that variations in an input signal received at the amplifier are not represented in the output signal produced by the amplifier. In order to address this problem, it is known to automatically adjust a gain value of the amplifier so that variations in incoming signal strength are less likely to result in saturation of the amplifier output. This modification of amplifier gain is referred to as automatic gain control and is achieved by an automatic gain control device (AGC).

In some applications, a DC average of the data pattern is used to control the AGC. The DC average of a signal or data pattern is indicative of the power involved with that pattern. A succession of “1” pattern has a DC average of 1. A succession of alternative “1” and “0” has a DC average of ½, while a succession of “0” has the DC average of 0. The term average used here means an average over a certain period of time. This period of time is referred to as an integration time constant of the AGC. The instantaneous value of the DC average is related to the number of “1” and “0” bits received during a preceding time interval equal to the integration time constant.

Since the patterns of data can vary widely, and include long successions of “1” or “0”, getting a good representation of the long term DC average, or power, of a data pattern, requires averaging the signal over an extended period of time. For that reason, AGC devices based on the DC average of the data pattern are made to have a relatively slow response as compared to data frequency. This reduces unwanted variation in amplifier gain due to data characteristics, as opposed to signal strength.

Burst mode data poses special problems for automatic gain control. Because no signal is present during a data gap, the integrated signal power perceived by a conventional AGC tends to diminish over the duration of the data gap. Since a diminution in received power is perceived by the AGC as representing a weak incoming signal strength, the AGC adjusts gain upward. To avoid unduly raising amplifier gain during data gaps, a conventional AGC must have a long integration time constant if it is to handle burst mode data.

A long time constant (slow response) AGC has its own problems, however. Such an AGC will not be very responsive to actual variation in signal strength over the course of a data burst. Consequently signal loss due to inadequate amplifier gain, and amplifier saturation, are both possible.

In burst mode data transmission, it is desirable for a receiving device to become active as quickly as possible after receiving a first signal transition of a preamble 207. One way to achieve rapid signal response is to increase the sensitivity of receiving devices. For example, in optical communication systems, Avalanche Photodiodes (APDs) may be used in combination with trans-impedance amplifiers to accomplish the desired receiver sensitivity.

APDs exploit an “avalanche breakdown” phenomenon in which current multiplication (i.e. amplification) occurs in response to incoming photons. To achieve avalanche breakdown in an APD, a reverse bias voltage is applied to create an electric field within a depletion region of the diode. The applied reverse bias voltage is near, but below, a breakdown voltage of the diode.

When incoming photons (light) are absorbed by the APD, hole-electron pairs (i.e., free electrons) are created within the depletion region of the diode. The electric field within the depletion region accelerates the hole and electron of each hole-electron pair away from one another and out of the depletion region. Under the influence of the electric field, free electrons are accelerated to an energy where collisions with atoms or ions create additional free electrons. This generates an “avalanche” of additional hole-electron pairs, resulting in an amplified current that is related to incident photon flux. The amount of amplification, or gain, of the APD increases with increasing reverse bias voltage.

Conventional digital networks rely on voltage levels to communicate high and low values (i.e., digital “1” and “0,” respectively). Because an APD provides current output, conversion of the current to a corresponding voltage is necessary for use with conventional networks. Transimpedance amplifiers (TIAs) are often used for this purpose in receivers for optical communication systems. To permit operation at high performance levels, for example at high frequencies, the input impedance must be kept low. Such low input impedance may be achieved by applying a negative feedback between an output and an input of a TIA.

A low input impedance arrangement makes a TIA sensitive to small variations in incoming signal amplitude. Under such circumstances, however, larger signal amplitude, and DC bias, can readily cause saturation of the TIA. Once the TIA has saturated, the output of the TIA does not respond effectively to changes at its input. Effective automatic gain control is, therefore, important for systems including TIAs coupled to APD's, and particularly important when such systems are used for burst mode data communication. In such systems, slow AGC response can reduce overall sensitivity of the receiver for a data pattern including data bursts and gaps.

### SUMMARY OF THE INVENTION

In light of the foregoing the inventors have concluded that there is a need for an improved device capable of adapting to varying data patterns, including data patterns in which data bursts are interspersed with gaps. The inventors have recognized that it is beneficial to have a datastream receiving device that provides differing response of an automatic gain control device during reception of different portions of a datastream. Accordingly, the inventors have realized that in some circumstances it is beneficial to have rapid AGC response during datastream gaps and comparatively slow gain variation during data bursts. In this way, an appropriate gain level is quickly determined soon after the arrival of a first transition of a data burst. Thereafter, the response of the AGC is slowed, so as to avoid spurious gain variation resulting from particular data patterns within the data burst. With the benefit of the following examples, one of skill in the art will understand that other improvements including other patterns of gain variation also offer benefits and characterize embodiments that fall within the scope of the invention as conceived by the inventors.

As will be described below, the inventors have developed various embodiments of the invention according to these and other discoveries. According to one embodiment of the invention, an improved device is suitable for use with, for example, an avalanche photodiode and accompanying transimpedance amplifier for improved overall sensitivity and responsiveness of an optical communications receiver. Accordingly, the present patent application describes methods and apparatus for improving data communications by selectively changing a time constant value of a signal receiving device.

In various embodiments, the devices and systems disclosed are adapted to provide optimized signal reception characteristics during a quiescent signal interval and during an active signal interval. For example, the embodiments disclosed include embodiments adapted to operate in a burst mode data system so as to respond effectively to both quiescent intervals and bursts of data. One embodiment of the invention includes a receiving device that responds rapidly to a signal transition that follows a quiescent interval so as to avoid the loss of leading data of a data burst, and thereafter responds less rapidly so as to avoid premature state transitions in the event of quiescent intervals within the data burst. One embodiment includes an automatic gain control device with an adaptable time constant. An exemplary automatic gain control device is adaptable by switching or otherwise changing a time constant thereof so as to be optimized for a type of or portion of a data pattern being received.

In an optical communications system, for example, an automatic gain control device is coupled to an avalanche photodiode and a transimpedance amplifier. One such embodiment includes an APD, a TIA, and an AGC device in which the time constant of an RC combination is controllable by switchingly coupling a capacitor in and out of parallel connection with a resistor. The AGC device is coupled to the avalanche photodiode and the transimpedance amplifier in such a way that the reverse bias voltage applied to the APD may be adjusted according to a DC average of an incoming data pattern to avoid saturation of the TIA. A switch device in the AGC device may be used to increase or decrease the time constant of the RC combination determining the DC averaging time period, thereby tailoring the response of the AGC device to characteristics of the incoming datastream. A resulting receiver exhibits improved responsiveness and sensitivity to data patterns including bursts of one or more packets interspersed with gaps.

A method according to one embodiment includes receiving an optical signal including a first portion of a data burst; selecting a first time constant value of an automatic gain control device in response to receiving the first portion of the data burst; controlling a gain of an avalanche photodiode according to the first time constant value while receiving at least a second portion of the data burst; selecting a second time constant value of the automatic gain control device subsequent to termination of the data burst; and controlling the gain of the avalanche photodiode according to the second time constant value during a time interval after termination of the data burst.

When employed in the context of optical communications, for example, one embodiment of the present invention significantly improves receiver sensitivity and responsiveness by adapting to varying data patterns including those with data bursts interspersed with gaps. Methods and devices embodying these advantages may be provided in a form suitable for use with conventional data transmission networks and at a reasonable cost.

The present invention together with the above and other advantages may best be understood from the following detailed description of the embodiments of the invention illustrated in the following drawings.

### BRIEF DESCRIPTION OF THE DRAWINGS

In the drawings:

FIG. 1 illustrates a simplified time domain graph of a portion of a datastream including bursts interspersed with gaps;

FIG. 2 illustrates a simplified timing diagram of a conventional data pattern including a burst having a preamble interspersed between gaps;

FIG. 3 illustrates, in block diagram form, a receiving device according to one embodiment of the invention;

FIG. 4a illustrates a simplified timing diagram of a data burst including a preamble interspersed between gaps.

FIG. 4b illustrates an exemplary timing for switching a time constant in accordance with one embodiment of the invention;

FIG. 5 illustrates a simplified schematic diagram of a receiver device formed in accordance with one embodiment of the invention;

FIG. 6 illustrates a simplified schematic diagram of a receiver device formed in accordance with one embodiment of the invention;

FIG. 7 illustrates a simplified schematic diagram of a receiver device formed in accordance with another embodiment of the invention;

FIG. 8 illustrates a simplified schematic diagram of a switchable receiver device formed in accordance with another embodiment of the invention;

FIG. 9 shows a flow diagram illustrating an exemplary method of adjusting an optical receiver in accordance with one embodiment of the invention; and

FIG. 10 illustrates an optical transmission system formed in accordance with another embodiment of the invention.

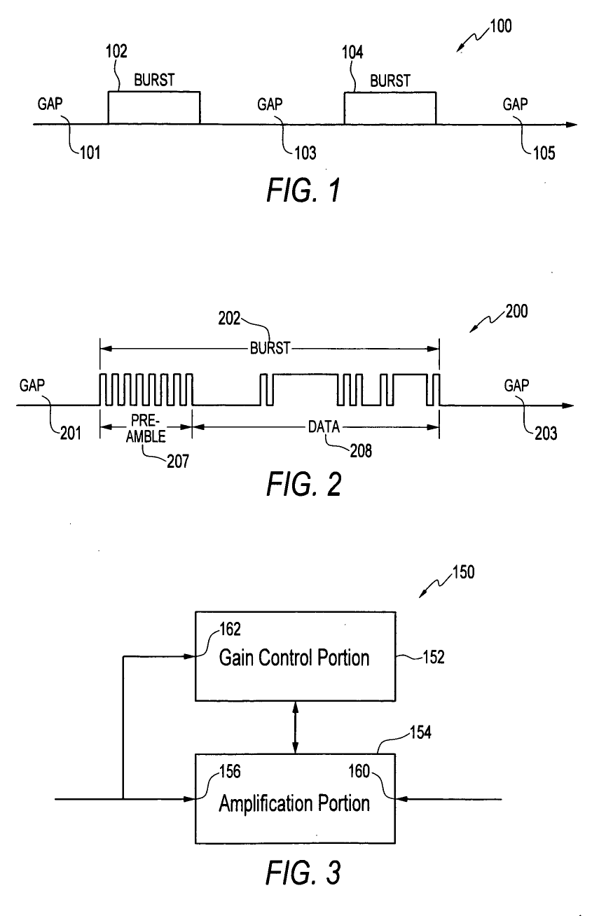

### DETAILED DESCRIPTION

The following description is provided to enable a person of ordinary skill in the art to make and use the disclosed inventions and sets forth the best modes presently contemplated by the inventors for carrying out their inventions. In the following description, for purposes of explanation, numerous specific details are set forth in order to provide a thorough understanding of the described inventions. It will be apparent to one skilled in the art, however, that the inventions may be practiced without these specific details. In other instances, structures and devices are shown in block diagram (or otherwise simplified) form for clarity of presentation.

In the following discussion, the singular term “signal” and plural term “signals” are used interchangeably and are to be understood as including analog or digital information, at a single frequency or a plurality of frequencies, and may or may not include coding, modulation, sideband information, or other features of signals or waveforms well known in the art. Furthermore, when reference is made to a “receiver,” “transmitter,” “output,” or “input,” previous process steps may have been utilized to form signals or waveforms compatible with these features. In addition, no particular order is required for the method steps described below, with the exception of those logically requiring the results of prior steps, for example controlling a gain according to a first time constant value may logically require the prior selection of the first time constant value. Otherwise, enumerated steps are provided below in an exemplary order which may be altered, for instance the several receiving steps may be rearranged or performed simultaneously.

FIG. 3 shows a signal receiver device 150 in block diagram form, according to one embodiment of the invention. The signal receiver device 150 includes a gain control device 152 and an amplification device 154. The gain control device 152 is signalingly coupled to the amplification device 154 by a communication device 156. According to the illustrated embodiment, the amplification device 154 includes an input port 158 and an output port 160. The input port 158 is adapted to receive a signal including an incoming data communication signal bearing payload data. The output port 160 is adapted to produce a signal including an amplified signal including data related to the payload data.

In one embodiment of the invention, the communication device 156 includes an electrical conductor. According to one embodiment of the invention, the gain control device 152 and the amplification device 154 mutually influence respective states of one another by, for example, electrical communication through the communication device 156. In one embodiment of the invention the gain control device 152 is adapted to exhibit a first gain control state during a first time interval and a second gain control state during a second time interval so that the amplification device 154 exhibits a first amplification state substantially during the first time interval and a second amplification state substantially during the second time interval. As will be described below in additional detail, according to one embodiment the first gain control state includes a relatively short integration time constant in the second gain control state includes a relatively long integration time constant. In a further embodiment, the state of the gain control device 152 is adapted to be influenced according to a further control signal received at an input port 162 thereof. As will become apparent upon review of the further description provided below, various embodiments may exhibit more than two gain control states. At least one embodiment will exhibit a continuum of gain control states according to the requirements of a particular application.

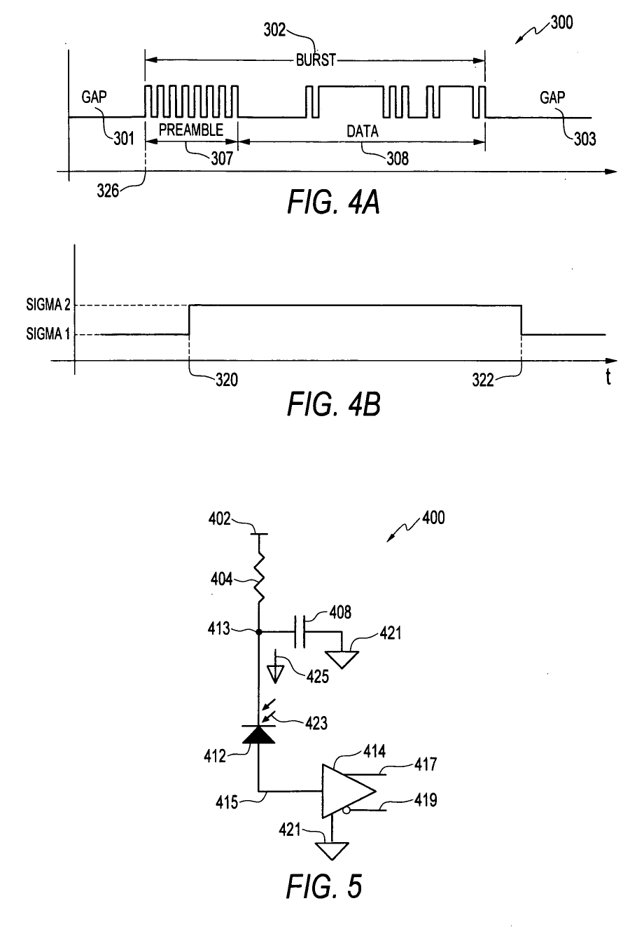

Referring to FIG. 4A, one sees a graphical representation of a signal 300 in time domain form. The illustrated signal 300 includes a data burst 302 between gaps 301, 303. The burst 302 includes a data portion 308 and a preamble portion 307 prepended to the data portion 308, similar to that described with reference to FIG. 2. In the illustrated example, the preamble portion 307 and the data portion 308 are chronologically sequential and adjacent to one another. Together, the preamble portion 307 and data portion 308 span a burst time interval 302 of some duration. In the illustrated embodiment, the burst time interval 302 is chronologically preceded by a first gap time interval 301 and followed by a second gap time interval 303. During the first gap time interval 301 and the second gap time interval 303, the signal is substantially quiescent; i.e., the signal channel is substantially free of data and preamble transitions.

Illustrated in FIG. 4B is a graphical representation 318 of a state, over time, of a receiver device such as, for example, the receiver device 150 of FIG. 3. During a first state time interval 311, the receiver device 150 is in a first device state Sigma 1. At a first transition time 320, the receiver device changes state to a second device state Sigma 2. Thereafter, the receiver device remains in second device state Sigma 2 for a second state time interval 312. Subsequently, at a second transition time 322 the receiver device again changes state and returns to the first device state Sigma 1. Thereafter, the receiver device remains in device state Sigma 1 for a third state time interval 313.

In an exemplary system associated with the signal of FIG. 4A, device state Sigma 1 corresponds to the receiver device having a relatively fast response to changes in signal state; i.e., a relatively short AGC integration time constant. Device state Sigma 2 corresponds to the receiver device having a relatively slow response to changes in the state; i.e., a relatively long AGC integration time constant as compared with the time constant of device state Sigma 1.

Accordingly, as illustrated, during time interval 301 the receiver device exhibits a short AGC integration time constant. At a time 326 a first signal transition of the preamble portion 307 is received at the receiver device. Thereafter, at first transition time 320, the receiver device changes state and begins to exhibit a long AGC integration time constant. This long integration time constant state persists until some time after a final signal transition of data burst 302 at a time 328. Thereafter, at second transition time 322, the receiver device resumes the short time constant state. This short time constant state Sigma 1 is maintained until some time after a further preamble transition is detected, or until some other state transition of the system.

One of ordinary skill in the art will appreciate that the signal illustrated in FIG. 4A is merely one example of many signaling arrangements that could be used for communicating data. For example, the preamble portion 307 of FIG. 4A shows a plurality of alternating bit states in a pattern intended to signal the start of a data burst. Many other preamble data patterns are possible, and may be used equally well within the context of the invention. In addition, other data communication schemes intended to fall within the scope of the invention would employ no preamble portion, or would employ multiple preamble portions or would employ a preamble portion followed by a gap of, for example, known duration intervening between the preamble portion and the data portion. In like fashion, the particular characteristics of the data portion illustrated are merely exemplary. Any number of signaling schemes could be used and benefit from the advantageous and novel aspects of the invention disclosed herewith.

According to a further embodiment of the invention, an optical receiver is provided with an avalanche photodiode and switchable automatic gain control. One embodiment of such a device may be formed using conventional techniques of constructing electronic devices and devices which are well known in the art.

FIG. 5 shows an optical receiver device 400 having automatic gain control. The optical receiver device 400 includes a photosensitive device such as an APD 412. The APD 412 is coupled at a first node 413 thereof to a resistive device 404 and at a second node 415 to an input of a TIA 414. The illustrated TIA 414 includes a double-ended output port having a first un-complemented output 417 and a second complemented output 419. One of skill in the art will appreciate that other output configurations of TIA 414 will be employed in different embodiments of the invention.

The TIA 414 also includes a ground node coupled to a source of ground potential 421. As noted above, the resistive device 404 is coupled to node 413. Resistive device 404 is also coupled to a source of supply voltage 402. The various electrical couplings identified above are formed with, for example, electrical conductors disposed between the enumerated devices. One of skill in the art will appreciate that such conductors will have more or less parasitic capacitance depending on, among other things, the characteristics of the particular conductor and on its placement in relation to other conductors and dielectric materials. In the optical receiver device 400 a parasitic capacitance 408 is shown coupling node 413 to, for example, the source of ground potential 421.

In operation, a voltage is impressed between nodes 413 and 415 by the source of supply voltage 402 to reverse bias the APD 412. This voltage depends on, for example, an electrical potential difference between supply 402 and the source of ground potential 421, a current/voltage characteristic of APD 412, an internal impedance of TIA 414, and an impedance of resistive device 404 taken in combination with parasitic capacitance 408.

An electrical current 425 flows through APD 412. This current includes a reverse bias leakage current of the APD 412, as well as an incremental current that depends on a magnitude of a flux of photons 423 (optical signal) received at APD 412 and on the reverse bias voltage between nodes 413 and 415. An increase in the power of the optical signal 423 reaching the APD 412 causes an increase in the current 425 through the APD 412. This results in a corresponding current increase through the resistive device 404. A voltage drop across resistive device 404 consequently increases according to the relation:
V_{R}=I_{APD}×R
Where V_{R} is a voltage drop across resistive device 404 I_{APD} is the current 425 through the resistive device 404, and R is the resistance value of the resistive device 404. This increase of the voltage drop across the resistive device 404 causes a corresponding decrease in the reverse bias voltage across the APD 412. According to this negative feedback effect, a gain of the APD 412 is reduced, to limit current 425.

The reverse current 425 through the APD 412 is small (being, according to one embodiment, in the micro-Ampere range). Accordingly, the resistive device 404 is selected to have a correspondingly large value so the above-noted voltage drop across the resistive device 404 is large enough to have the desired effect.

One of skill in the art will appreciate, however, that the combination of a large resistance value of resistive device 404 and the parasitic capacitance 408 can result in an RC combination having an undesirably long time constant according to the formula:
τ=R×Cₚ
This long time constant slows the response of the AGC. In addition, the value of the time constant is difficult to predict since the value of the parasitic capacitance depends on various process and environmental parameters that may be difficult to control.

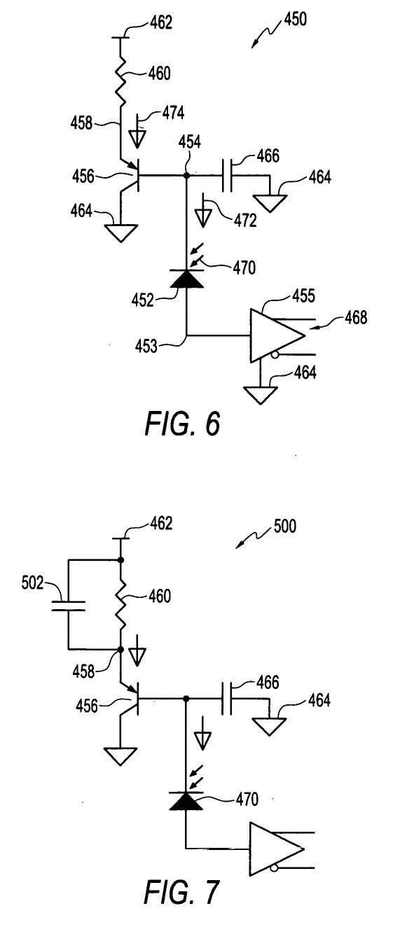

FIG. 6 shows another embodiment of an optical receiver device 450 having automatic gain control and better sensitivity as compared with the optical receiver device 400 of FIG. 5. The optical receiver device 450 includes a photosensitive device such as an APD 452. The APD 452 is coupled at a first node 454 to a base of a transistor 456 and at a second node 453 to an input of a TIA 455. The TIA 455 also includes a connection to a source of ground potential 464 and a signal output 468 (here illustrated as a double ended signal output). A third node 458 is mutually coupled to an emitter of transistor 456 and a resistive device 460.

Resistive device 460 is also coupled to a source of supply voltage 462. A collector of transistor 456 is coupled to a source of ground potential 464. In the illustrated embodiment, the transistor is shown as a PNP transistor. A parasitic capacitance 466 couples node 454 to the source of ground potential 464. One of ordinary skill in the art will appreciate, that another switch device, such as an NPN transistor may be used in an appropriately designed circuit.

In operation, the APD 452 is reverse biased between nodes 454 and 453. The APD receives an optical signal 470 and a responsive variation of a current 472 flowing through the APD is received at the input of the TIA 455. Current 472 also controls transistor 456 to produce a corresponding variation in emitter current 474. Emitter current 474 produces a voltage drop across resistive device 460 to moderate current 472. The emitter current 474 is equal to the base current 472 multiplied by the transistor gain according to the formula:
I_{E}=I_{APD}×(1+β)
Where I_{E} is emitter current 474, I_{APD} is current 472 and β is a gain parameter of the transistor 456. Therefore, the voltage drop across the resistive device 460 is given by the formula:
V_{R}=V_{APD}−V_{E}=I_{APD}×R
Where V_{R} is the voltage drop across resistive device 460, V_{APD} is the voltage at node 454, V_{E} is the voltage at node 458, and R is the value of resistive device 460.

Assuming an exemplary transistor 456 with a β value of approximately 100, the current 474 through the resistive device 460 is approximately 100 times larger than the base current 472 that flows through the APD 452 to the TIA 455. Consequently, as compared with resistive device 404 of receiver device 400 (FIG. 5) resistive device 460 can be made much smaller to achieve the same automatic gain control effect.

As in the FIG. 5 embodiment, the AGC time constant of receiver device 450 is related to the values of resistive device 460 and parasitic capacitance 466 according to the formula:
τ_{effective}=R_{effective}×Cₚ
The effective resistance, viewed through transistor 456 of resistive device 460 is given by the formula:
R_{effective}=R/(1+β)
Consequently the relationship between the time constants of receiver devices 400 and 450 is:
τ_{effective}=τ/(1+β)
Therefore, assuming that parasitic capacitances 408, 466 of receiver devices 400 and 450 respectively are comparable, receiver device 450 responds much more rapidly to changes in the level of the optical signal 470 than does receiver device 400.

As discussed above, rapid AGC response is particularly desirable in the handling of burst mode data since the AGC device tends to perceive a data gap as a low signal and to attempt to compensate by strongly raising gain. It is desirable that the AGC correct gain downward promptly after a first transition of a data burst is received to avoid saturation of the TIA. In these circumstances, a short AGC time constant produces the desired result.

One disadvantage of such a short AGC time constant is that the AGC may overcompensate for a series of low bits found within the payload data of a data burst. Referring to FIG. 4A, one sees that a series of low bits may be present within the payload data, either as a part of the communication protocol 330, or intrinsic to the data being communicated 332. If the AGC increases gain too rapidly saturation of the TIA and loss of data may occur following a sequence of low bits.

FIG. 7 illustrates how the AGC time constant can be adjusted by design through the addition of a capacitive device. FIG. 7 shows a receiver device 500 that is like receiver device 450 in most respects. Receiver device 500 includes an APD 470 that is coupled to a base of a transistor 456. An emitter of the transistor 456 is coupled at a node 458 to a resistive device 460 which is in turn coupled to a source of supply voltage 462. Also, as in receiver device 450, a parasitic capacitance 466 couples the base of transistor 456 to a source of ground potential 464. In receiver device 500, a capacitive device 502 is coupled in parallel with resistive device 460 between source of supply voltage 462 and node 458. The capacitance value of capacitive device 502 is selected to be much larger than a capacitance value of parasitic capacitance 466:
C>>C_{P}

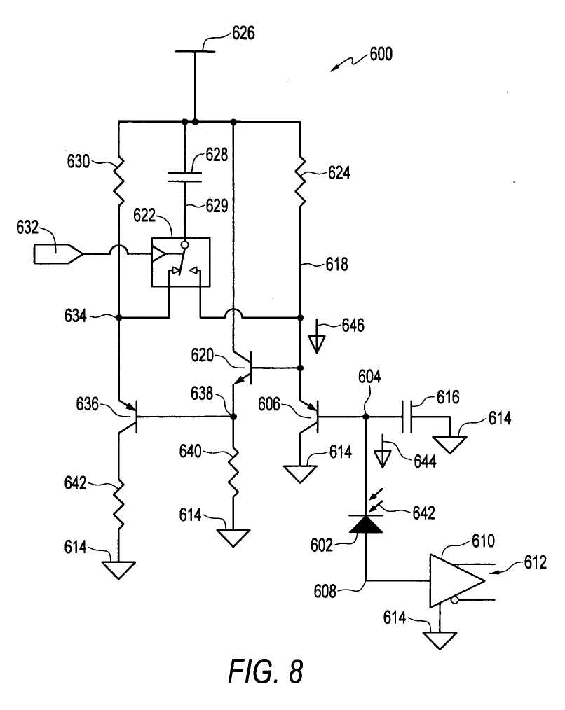

As will be understood by one of skill in the art, the AGC time constant of the receiver device 500 will thus be significantly longer than the AGC time constant of receiver device 450. Also, the AGC time constant can be made fairly insensitive to variation of the parasitic capacitance 466. Moreover, because the capacitance of capacitive device 502 may generally be specified much more precisely than the value of the parasitic capacitance 466, the AGC time constant of receiver device 450 may be predetermined with some precision. It will also be understood by one of skill in the art, however, that the addition of capacitor 502 reduces the ability of the AGC to respond quickly to the arrival of a data burst after a data gap. Accordingly, FIG. 8 shows an embodiment of the invention including a changeable time constant AGC device.

FIG. 8 shows, in simplified electrical schematic form, an optical signal receiver device generally designated 600 in accordance with an embodiment of the present invention. The optical signal receiver device 600 includes an APD 602. The APD 602 is coupled at a first node 604 to a base of a first transistor 606. The APD 602 is coupled at a second node 608 to an input of a TIA 610. The illustrated exemplary TIA 610, has a double ended signal output 612 and a node coupled to a source of ground potential 614. Node 604 is coupled by a parasitic capacitance 616 to the source of ground potential 614. Also coupled to the source of ground potential 614 is a collector of transistor 606. An emitter of transistor 606 is coupled to node 618, which is also coupled to a base of a second transistor 620, a first output terminal of a switch device 622 and a resistive device 624. Also coupled to resistive device 624 is a source of supply voltage 626. In addition to the resistive device 624, the source of supply voltage 626 is coupled to a collector of transistor 620, a capacitive device 628 and a further resistive device 630. Switch device 622 has a signal input terminal coupled to capacitive device 628 at node 629, and a control input terminal coupled to a node 632. Switch device 622 also has a second output terminal coupled to a further node 634 which is, in turn, coupled to resistive device 630 and to an emitter of a third transistor 636. A further node 638 is mutually coupled to a base of transistor 636, an emitter of transistor 620, and through a further resistive device 640 to the source of ground potential 614. A collector of transistor 636 is coupled through yet another resistive device 642 to the source of ground potential 614.

In the illustrated embodiment, transistor 606 and transistor 636 are shown as PNP bipolar junction transistors and transistor 620 is shown as an NPN bipolar junction transistor. One of ordinary skill in the relevant art will appreciate, however, that another embodiment of the invention could readily be prepared using, for example, transistors of complementary polarity, or using other devices such as, for example, alternate transistor forms, free electron tubes, or other linear and nonlinear control devices. The present disclosure would make a wide variety of such embodiments immediately clear to one of ordinary skill in the art.

In the illustrated embodiment, the polarity of the source of supply voltage 626 is presented as being positive with respect to the source of ground potential 614. Consequently the APD 602 is placed in reverse bias by operation of the illustrated combination of components. Again, however, one of skill in the art would appreciate that an alternative embodiment could readily be prepared including a source of supply voltage 626 having a negative electrical potential with respect to the source of ground potential 614.

The switch device 622 is shown as a single pole double throw mechanical switch device. Again, one of skill in the art will appreciate that this is merely a schematic illustration of the switch device. In actual practice, the switch device is chosen to be one of a wide variety of switch devices and a corresponding plurality of embodiments. For example, the switch device 622 may include one or more transistors or other switch devices such as, for example, a bipolarq junction transistor (BJT) a field effect transistor (FET) such as a junction field effect transistor (JFET) or an insulated gate field effect transistor (IGFET), a nano-tube transistor or other nanoscale solid-state device, a silicon-controlled rectifier (SCR), a triac, a free electron tube device such as, for example, a triode, an electro-mechanical relay, a magnetic reed switch, a microelectronic mechanical system (MEMS) switch device (including a nanoscale MEMS switch device) and a combination of one or more of the foregoing switch devices.

As will be discussed further below, as is evident from the illustration, the switch device 622 allows the capacitive device 628 to be switchingly coupled in parallel with resistive device 624 between the source of supply voltage 626 and node 618 during a first time interval. During a second time interval, the capacitive device 628 is switchingly decoupled from resistive device 624. Consequently, the switch device 622 allows the optical receiver device 600 to alternately exhibit either a relatively long AGC time constant when the capacitive device 628 is coupled to node 618, or to exhibit a relatively short AGC time constant when the capacitive device 628 is decoupled from node 618 (as shown).

With reference now to FIG. 8, FIG. 4A and FIG. 4B, the switch device 622 is adapted to assume first and second states corresponding to first device state Sigma 1 and second device state Sigma 2 respectively. When the switch device 622 is in the illustrated state so that node 629 is coupled to node 634, the receiver device is in device state Sigma 1; i.e. the short time constant state. When the switch device 622 is in the alternate state, so that node 629 is coupled to node 618, the receiver device is in device state Sigma 2; i.e. the long time constant state. As discussed above, the illustration of switch device 622 is merely a schematic representation. One of ordinary skill in the art will appreciate that switch device 622 may be implemented in a wide variety of ways, as known in the art, and accordingly the state transition of switch device 622 is likely to be, for example, an electronic state transition such as the switching of a transistor.

One of skill in the art will readily appreciate that, if capacitor device 628 were discharged at the time of switching, the switching of capacitive device 628 into a parallel coupling with resistive device 624 would cause a transient response within the receiver device 600. Such a transient response would constitute undesirable noise, and have the potential to introduce errors into the datastream. Accordingly, it is desirable to precharge the capacitive device 628 prior to switching so that node 629 is at the same potential as node 618 with respect to the source of ground potential 614.

On further consideration of the schematic diagram of FIG. 8, it will be apparent to one of ordinary skill in the art that the illustrated combination of transistors 620 and 636, along with resistive devices 630, 640 and 642, form a voltage follower arrangement that is adapted to maintain a voltage at node 634 (and therefore at node 629) that is substantially instantaneously dependent on, and equal to, a voltage at node 618 assuming an appropriate selection of device parameters (a matter of routine for one of skill in the art). One notes that the base of transistor 620 is coupled to node 618. The voltage at the emitter of transistor 620 is therefore given by the formula:
V_{A}=V_{E}−V_{BE-620}
where VA is the instantaneous voltage at node 638, VE is the instantaneous voltage at node 618, and V_{BE-620} is the intrinsic base-emitter voltage of transistor 620. The instantaneous voltage at node 634 is given as V_{REF} according to the formula:
V_{REF}=V_{A}+V_{BE-636}
where VA is again the instantaneous voltage at node 638 and V_{BE-636} is the intrinsic base-emitter voltage of transistor 636. Assuming that transistors 620 and 636 are suitably matched so that V_{BE-620}=V_{BE-636}
V_{REF}=V_{E}−V_{BE-620}+V_{BE-636}=V_{E}
Accordingly, the illustrated combination serves to maintain the voltage at node 634 (V_{REF}) substantially equal to the voltage at node 618 (V_{E}) without substantially loading node 618.

Summarizing then, devices 620, 636, 630, 640 and 642 of the receiver device 600 provide a voltage follower for pre-charging of the capacitive device 628. Considering now the remaining devices 628, 624, 606, 602 and 610 of the receiver device 600, one sees that the receiver device 600 of FIG. 8 is, in its short AGC time constant configuration, substantially similar to the receiver device 450 of FIG. 6, and in its long AGC time constant configuration substantially similar to the receiver device 500 of FIG. 7. Accordingly, referring to the descriptions of devices 450 and 500 provided above one of skill in the art will understand the operation of optical signal receiver device 600 as follows.

During a data gap, the capacitive device 628 is precharged to an instantaneous voltage substantially equal to an instantaneous voltage across resistive device 624. Thereafter, a databurst optical signal 642, including a flux of photons, is received at the APD 602. The optical signal 642 induces a photocurrent 644 in APD 602, and consequently in the base of transistor 606. A responsive current 646 flows into the emitter of transistor 606, and therefore through resistive device 624. A resulting increase in a voltage drop across resistive device 624 serves to reduce a reverse bias voltage across APD 602, thereby limiting current flow 644 through (and amplification by) APD 602 in a negative feedback effect. Because capacitive device 628 is not coupled in parallel with resistive device 624, this negative feedback response occurs comparatively rapidly. Desirably, the response is rapid enough to avoid TIA 610 saturation and significant loss of signal data and preferably rapidly enough to avoid significant loss of preamble data.

It should be noted that in the exemplary preamble of FIG. 4A the rate of alternation between 1 and 0 states of the received signal is rapid, and therefore a short AGC time constant is appropriate. Once the preamble has been received and the AGC has established a gain appropriate to the power level of the preamble, the receiver registers the presence of the data burst and triggers a transition of the switch device so that the pre-charged capacitive device 628 is coupled in parallel with resistive device 624. This places the AGC in long AGC time constant mode, which is appropriate for regular data patterns. After the data burst is terminated, the AGC time constant is switched back to the short AGC time constant.

In various embodiments, the switch device 622 as shown in FIG. 8 may change its state in response to a wide variety of data patterns, enabling the optical receiver device 600 to achieve improved sensitivity and responsiveness. In one embodiment, for example, the data patterns include a plurality of sequentially alternating bits as shown in the exemplary preamble 307 of FIG. 4A. Of course, it is not required that the switch device 622 change states in the exact manner described above, but may change states in response to commands, instructions, indicators, or signals of other types and origins, to accomplish adaptation of the receiver to other data patterns or arrangements. For example, the state of switch device 622 may be controlled manually or automatically in accordance with optical signals characterized by continuous or discontinuous data bursts received at the optical receiver device 600 or at another location, device, or circuit. The state of switch device 622 may be controlled, for example, by a triggering device including, or coupled to, a clock and data recovery device (e.g., phase locked loop device) as described above. The state of switch 622 may be controlled by a wide variety of device elements, processors, actuators, or other enabling devices, including an RC circuit device adapted to detect the presence of a data burst without deviating from the spirit and scope of the present invention.

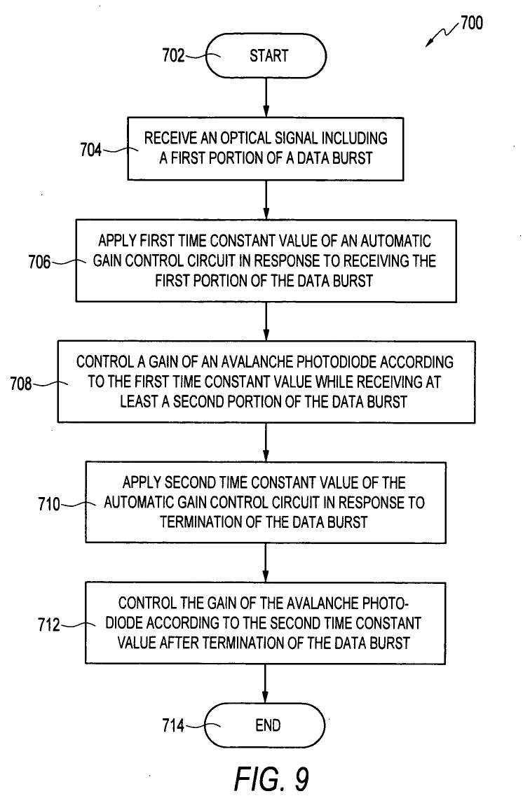

FIG. 9 shows a flow diagram representation of a method of adjusting an optical receiver generally designated 700 in accordance with an aspect of the present invention. The method 700 includes a receiving step 704, a first time constant selection step 706, a first controlling step 708, a second time constant selection step 710, and a second controlling step 712.

The method 700 begins at step 702 and proceeds to receiving step 704 in which an optical signal including a first portion of a data burst is received, for example similar to that described above with reference to FIG. 4.

In first time constant selection step 706, the received first portion of the data burst triggers selection of a first time constant value associated with an automatic gain control (AGC) device. For example, given an optical receiver device of the type illustrated in FIG. 8 and a data burst 302 of the type illustrated in FIG. 4A, the preamble 307 of the burst 302 triggers device 622 to change states to its long time constant state, as discussed above. In this example, the first time constant value selected is the long time constant value associated with resistor device 624 and capacitor device 628, and may be approximated by the expression:
τ1=R2×C1

The selection step 706 may be accomplished by recognition of the first portion of the data burst, for example the preamble 307 may be recognized, triggering the change of state of the switch 622 as shown in FIG. 8. However, a person skilled in the art would appreciate that selection of a first time constant value in response to receiving the first portion of the data burst may be accomplished in a variety of ways without departing from the spirit or scope of the present invention.

The method 700 proceeds to first controlling step 708, in which the AGC device controls a gain of an APD according to the first time constant value selected in prior selection step 706, the AGC device operating to prevent saturation of a TIA coupled to the APD for the purpose of converting a photocurrent output of the APD into a corresponding voltage. For example, the RC combination (described above with reference to FIG. 8) formed when capacitive device 628 is connected (i.e. the long time constant state of switch device 622) operates to increase the voltage drop at resistive device 624 and hence decrease the reverse bias voltage applied to APD 602 in response to incoming photons at the APD 602. The decrease in the reverse bias voltage applied to APD 602 results in a decrease in the amplified photocurrent IAPD 644, thereby preventing saturation of the TIA 614 in response to arrival of a data burst in the form of photons at APD 602. In this example, at least the data portion 308 of burst 302 (see FIG. 4)A is received while the AGC device controls the gain according to the first time constant value selected.

The method proceeds to second time constant selection step 710, in which termination of the received data burst triggers selection of a second time constant value associated with the AGC device. For example, given the optical receiver device of FIG. 8 and the data burst 302 of FIG. 4A, termination of the burst 302 triggers switch 622 to change states to its short time constant state (i.e. pole at left position in FIG. 8; see indicator 313 in FIG. 4). In this example, the second time constant value selected is the short time constant value associated with resistive device 624 and and Cp 616, and may be approximated by the expression:
τ2=R×Cₚ

The selection step 710 may be accomplished by recognition that a received data burst has ended. According to one embodiment, the preamble 307 may include burst size information. In such an embodiment, the burst size information is used to control a state transition of the system to and/or from a long time-constant state. For example, according to one embodiment, a change of state of the switch device 622 occurs when a counter registers a number of data values matching a preset threshold value. In one embodiment, the threshold value is equal to a number of bits in a preamble portion of a data burst. In another embodiment, the threshold value is less than the number of bits in the preamble portion. However, a person skilled in the art would recognize that selection of a second time constant value in response to termination of the data burst may be accomplished in a variety of ways without departing from the spirit or scope of the present invention, for example termination may be signaled by a predetermined amount of time passing without receiving signals in the form of incoming photons or otherwise.

The method 700 proceeds to second controlling step 712, in which the AGC device controls a gain of the APD according to the second time constant value selected in prior selection step 710, the AGC device operating to prevent saturation of the TIA coupled to the APD. For example, the RC combination (described above with reference to FIG. 8) formed when capacitor 628 is disconnected (i.e. the short time constant state of switch 622 as shown in FIG. 8) operates to adjust the reverse bias voltage applied to APD 602 and hence adjust the amplified photocurrent IAPD to prevent saturation at the TIA 612 in accordance with the second (short) time constant value selected in selection step 710. In this way, the AGC device may respond more quickly to incoming data patterns in the form of photons at APD 602, increasing sensitivity and responsiveness of the optical receiver device 600.

The method then proceeds to step 714, where it ends until another optical signal is received.

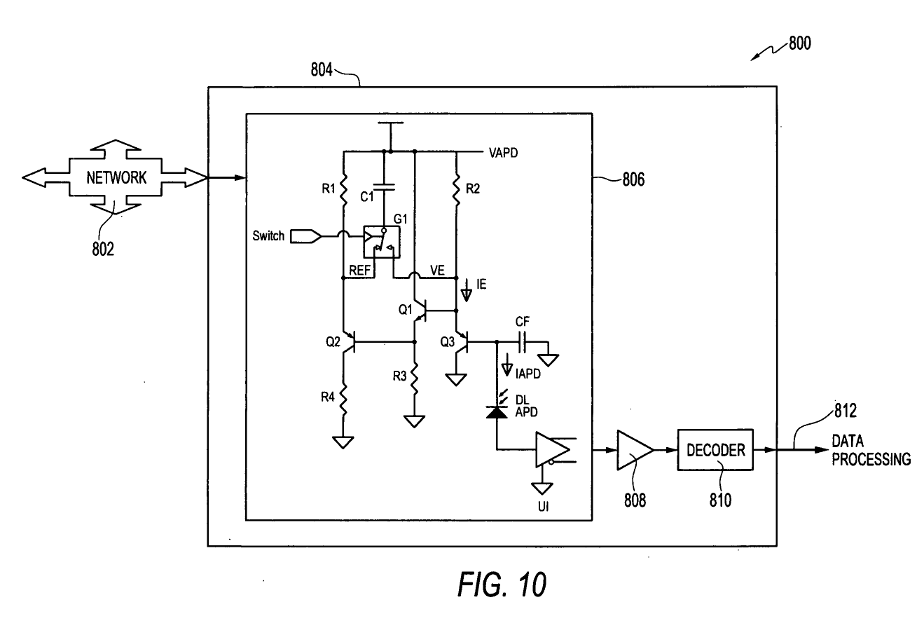

An optical transmission system 800 utilizing an automatic gain control device with switchable time constant in accordance with an aspect of the present invention is illustrated in FIG. 10. The optical transmission system 800 includes a source of optical signals 802, an optical reception device 804, and a data processing link 812. The source of optical signals 802 may include, for example, an optical communications network coupled via an optical transmission conduit such as a fiber optic cable or other physical medium. Of course, it should be apparent that the source of optical signals 802 is not so limited, and may include one or a plurality of transmission and reception devices configured for use with optical data transmission and configured to transmit analog or digital data signals or other signals desired to be received. The source of optical signals 802 may include amplifiers, pre-amplifiers, or other components for optical transmission as are well known in the art.

The optical reception device 804 includes an optical receiver device 806, at least one amplifier 808, and a decoder 810. The optical receiver device 806 may, for example, be configured as described above with reference to FIG. 8 and operate in accordance with the present invention. The output signals from the optical receiver device 806 are coupled to at least one amplifier 808 and then to decoder 810, permitting the voltage output of the transimpedance amplifier (TIA) to be converted into information in a more convenient form (e.g. digital bits). The result is coupled via data processing link 812 for further processing, for example to a semiconductor processor or computer (not shown) for manipulation and display. It should be appreciated by those skilled in the art that the operation of optical reception device 804 may include the reception and recovery of a wide variety of digital and/or analog data for use in a broad array of applications without departing from the spirit and scope of the present invention.

As illustrated in the preceding discussion and accompanying Fig.s, the method and apparatus of the present invention represent an improvement in the state of the art for optical receivers and associated methods. The present invention provides an optical receiver device including an APD, a TIA, and an AGC device having a switchable time constant. The AGC device is coupled to the avalanche photodiode and the transimpedance amplifier in such a way as to avoid saturation of the TIA in response to incoming optical data. The resulting receiver exhibits improved responsiveness and sensitivity to data patterns including bursts of one or more packets interspersed with gaps.

While the exemplary embodiments described above have been chosen primarily from the field of optical communication, one of skill in the art will appreciate that the principles of the invention are equally well applied, and that the benefits of the present invention are equally well realized in a wide variety of other communication systems including, for example, electronic medication systems. Further, while the invention has been described in detail in connection with the presently preferred embodiments, it should be readily understood that the invention is not limited to such disclosed embodiments. Rather, the invention can be modified to incorporate any number of variations, alterations, substitutions, or equivalent arrangements not heretofore described, but which are commensurate with the spirit and scope of the invention. Accordingly, the invention is not to be seen as limited by the foregoing description, but is only limited by the scope of the appended claims.

What is claimed is:

1. A signal receiver comprising:
a signal sensing device; and
a signal receiving device, said signal receiving device being operatively coupled to said signal sensing device, said signal receiving device being adapted to receive a first signal including a control signal from said signal sensing device and a second signal including a datastream, said signal receiving device being adapted to assume a first device state during a first data gap time interval responsive to a first state of said control signal, said signal receiving device being adapted to assume a second device state during a second data burst time interval responsive to a second state of said control signal.

2. A signal receiver as defined in claim 1 further comprising:
an automatic gain control device, said automatic gain control device being adapted to adjust a gain of said signal receiving device to a first gain value in accordance with said first device state, said automatic gain control device being adapted to adjust said gain of said signal receiving device to a second gain value in accordance with said second device state.

3. A signal receiver as defined claim 2 wherein said signal receiving device is adjusted to said first gain value during said first data gap time interval and said signal receiving device is adjusted to said second gain value during said second data burst time interval, said first gain value being substantially higher than said second gain value.

4. A signal receiver as defined in claim 2 wherein said automatic gain control device is adapted to have a first integration constant value during said first data gap time interval and said automatic gain control is adapted to have a second integration constant value during said second gap time interval, said first integration constant value being substantially shorter than said second integration constant value.

5. A signal receiving device comprising:
a signal receiving device having at least a first high gain state and a second low gain state; and
a signal sensing device coupled to said signal receiving device, said signal sensing device being adapted to transition said signal receiving device from said first high gain state into said second low gain state in response to a received data burst.

6. A method of controlling a receiver sensitivity comprising:
diminishing an amplification value of a receiver device during reception of a data burst; and
increasing said amplification value of said receiver device during reception of a data gap.

7. A method of controlling a receiver device comprising:
integrating an incoming signal with a first integrating device having a first time constant during a first time interval to produce a first gain state of a receiver device; and
integrating said incoming signal with a second integrating device having a second time constant during a second time interval to produce a second gain state of said receiver device, said first and second integrating devices being selected according to a state of said incoming signal.

8. A data receiver device comprising:
an amplifier with an automatic gain control device; and
a signal sensor device, said signal sensor device being coupled to said automatic gain control device to cause a relatively higher gain during a first gap time interval of a received signal and to cause a relatively lower gain during a second data burst time interval of said received signal.

9. An optical receiver device, comprising:
(a) an avalanche photodiode coupled to an optical signal source;
(b) a transimpedance amplifier coupled to said avalanche photodiode; and
(c) an automatic gain control device including at least one resistor, at least one capacitor, and a switch, configured to adjust an amplification characteristic of the avalanche photodiode;
(d) wherein said switch is configured to selectively connect said at least one capacitor and thereby select one of a plurality of time constant values associated with said automatic gain control device.

10. An optical receiver device as in claim 9, wherein an optical signal received via said optical signal source includes at least one data burst and at least one gap, and said automatic gain control device is configured such that at least one of said plurality of time constant values is tailored for use during a portion of said at least one data burst and at least another of said plurality of time constant values is tailored for use during a portion of said at least one gap.

11. An optical receiver device as in claim 9, wherein said switch is configured to connect said at least one capacitor in response to recognition of a preamble portion of said at least one data burst.

12. An optical receiver device as in claim 9, wherein said switch is configured to disconnect said at least one capacitor in response to termination of said at least one data burst.

13. An optical receiver device as in claim 9, wherein said switch is configured to connect said at least one capacitor in response to said received optical signal, whereby said automatic gain control device adjusts said amplification characteristic according to a first time constant value during at least said portion of said at least one data burst and said automatic gain control device adjusts said amplification characteristic according to a second time constant value during at least said portion of said at least one gap.

14. An optical receiver device as in claim 9, wherein a first time constant of said plurality is tailored to diminish a response of said automatic gain control device to short term variations in said at least one data burst.

15. An optical receiver device as in claim 9, wherein a second time constant of said plurality is tailored to increase sensitivity of said automatic gain control device to variations in said optical signal.

16. An optical receiver device as in claim 9, wherein said automatic gain control device includes an RC combination that adjusts a reverse bias voltage of said avalanche photodiode in response to an approximate average power of an optical signal received via said optical signal source.

17. An optical receiver device as in claim 9, further comprising a transistor coupled between said at least one resistor and said avalanche photodiode, the transistor configured to permit a smaller magnitude photocurrent of said avalanche photodiode to control a larger magnitude current applied to said resistor.

18. An optical receiver device as in claim 9, wherein said automatic gain control device is configured such that a voltage across said at least one capacitor is equal to a voltage across said at least one resistor.

19. A method of adjusting an optical receiver, comprising:
(e) receiving an optical signal including a first portion of a data burst;
selecting a first time constant value of an automatic gain control device in response to said receiving of said first portion of said data burst;
(g) controlling a gain of an avalanche photodiode in accordance with said first time constant value while receiving at least a second portion of said data burst;
(h) selecting a second time constant value of the automatic gain control device in response to termination of said data burst;
(i) controlling the gain of the avalanche photodiode in accordance with said second time constant value after said termination of said data burst.

20. A method as in claim 19, wherein said first portion of said data burst includes a preamble.

21. A method as in claim 20, wherein said preamble includes a succession of alternating high and low values.

22. A method as in claim 19, wherein said second portion of said data burst includes data intended for transmission.

23. A method as in claim 19, wherein said controlling said gain of said avalanche photodiode in accordance with said first time constant value includes using an RC combination that approximates an average power of said optical signal over a first time period and adjusting a reverse bias voltage of said avalanche photodiode in response to the average.

24. A method as in claim 19, wherein said controlling said gain of said avalanche photodiode in accordance with said second time constant value includes using an RC combination that approximates an average power of said optical signal over a second time period and adjusting a reverse bias voltage of said avalanche photodiode in response to the average.

25. A method as in claim 19, wherein said first time constant value is tailored to diminish a response of said automatic gain control device to short term variations in said second portion of said data burst.

26. A method as in claim 19, wherein said second time constant value is tailored to increase sensitivity of said automatic gain control device to variations in said optical signal.

27. An optical transmission system, comprising:
(j) a source of optical signals;
(k) an optical reception device including an optical receiver device coupled to receive optical signals from said source of optical signals; and
(l) a data processing link coupled to receive an output of said optical reception device;
(m) wherein said optical receiver device includes an avalanche photodiode coupled to an optical signal source, a transimpedance amplifier coupled to said avalanche photodiode, and an automatic gain control device including at least one resistor, at least one capacitor, and a switch, configured to adjust an amplification characteristic of the avalanche photodiode, wherein said switch is configured to selectively connect said at least one capacitor and thereby select one of a plurality of time constant values associated with said automatic gain control device.

28. An optical transmission system as in claim 27, wherein said optical signals include at least one data burst and at least one gap, and said switch being configured to connect said at least one capacitor in response to said optical signals, whereby said automatic gain control device adjusts said amplification characteristic according to a first time constant value during at least a portion of said at least one data burst and said automatic gain control device adjusts said amplification characteristic according to a second time constant value during at least a portion of said at least one gap.

29. An optical transmission system as in claim 28, wherein said first time constant value is tailored to diminish a response of said automatic gain control device to short term variations in said at least one data burst.

30. An optical transmission system as in claim 28, wherein said second time constant value is tailored to increase sensitivity of said automatic gain control device to variations in said optical signals.
